(19) United States
(12) Patent Application Publication
(10) Pub. No.: US 2014/0177910 A1
(43) Pub. Date: Jun. 26, 2014

(54) DEVICE, METHOD, AND COMPUTER PROGRAM PRODUCT FOR DETECTING OBJECT

(71) Applicant: Kabushiki Kaisha Toshiba, Tokyo (JP)

(72) Inventor: Kosuke Haruki, Tachikawa-shi (JP)

(21) Appl. No.: 13/923,101

(22) Filed: Jun. 20, 2013

(30) Foreign Application Priority Data
Dec. 20, 2012 (JP) 2012-278032

(51) Int. Cl. G06K 9/00

(52) U.S. Cl. CPC G06K 9/00536
USPC 382/103

(57) ABSTRACT

According to one embodiment, a device for detecting an object includes a first detection processor, a determination module, an area setting module, and a second detection processor. The first detection processor is configured to detect an object to be detected with respect to a frame image that constitutes input moving image data, with a first algorithm for searching for an area having a feature value similar to a feature value of the object by learning. The area setting module is configured to set, when a travel is smaller than a threshold, a second detection area inside a first detection area in which the object is detected with the first algorithm. The second detection processor is configured to detect, the object in the second detection area with a second algorithm for searching without learning for the movement destination of a feature area in the frame image.

### CROSS-REFERENCE TO RELATED APPLICATIONS

This application is based upon and claims the benefit of priority from Japanese Patent Application No. 2012-278032, filed Dec. 20, 2012, the entire contents of which are incorporated herein by reference.

### FIELD

Embodiments described herein relate generally to a device, method, and computer program product for detecting an object.

### BACKGROUND

In the field of computer vision, when object tracking is performed by a camera, there have been conventionally known various kinds of object detection algorithms. Among such object detection algorithms, an algorithm is known for searching for an area having a feature value similar to the feature value of an object to be detected by learning (hereinafter, referred to as “a first algorithm”) or an algorithm for searching for a movement destination of a characteristic point or a feature area in an image without learning (hereinafter, referred to as “a second algorithm”).

With the first algorithm, an object can be detected even when an image of the object is blurred by being defocused. However, a detection position may be deviated for each frame or the detection position may be deviated even when the object remains stationary.

When the second algorithm is used for detecting an object, even when an input image uniformly moves as a whole, a displacement of the image can be precisely measured by tracking a characteristic point. However, due to the effect of a feature value of a background of the object to be detected, it may be difficult to precisely track the object to be detected.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view illustrating the external appearance of a computer according to an embodiment;

FIG. 2 is an exemplary block diagram schematically illustrating the constitution of the computer in the embodiment;

FIG. 3 is an exemplary block diagram illustrating a part of the functional constitution of the computer in the embodiment;

FIG. 4 is an exemplary view for explaining about the setting of a threshold in the embodiment;

FIG. 5 is an exemplary view for explaining object detection processing in the embodiment;

FIG. 6 is an exemplary flowchart illustrating the procedures of the object detection processing in the embodiment;

FIG. 7 is an exemplary view illustrating an example of detecting an object with a first algorithm in a conventional example; and

FIG. 8 is an exemplary view illustrating an example of detecting an object with a second algorithm in the conventional example.

### DETAILED DESCRIPTION

In general, according to one embodiment, a device for detecting an object includes a first detection processor, a determination module, an area setting module, and a second detection processor. The first detection processor is configured to detect an object to be detected with respect to a frame image that constitutes input moving image data, with a first algorithm for searching for an area having a feature value similar to a feature value of the object by learning. The determination module is configured to determine whether a travel based on movement of the object is smaller than a threshold. The area setting module is configured to set, when the travel is smaller than the threshold, a second detection area inside a first detection area in which the object is detected with the first algorithm. The second detection area is smaller in size than the first detection area. The second detection processor is configured to detect, when the travel is smaller than the threshold, the object in the second detection area with a second algorithm for searching without learning for the movement destination of a feature area in the frame image.

In the present embodiment, an example such that a device, method, and program for detecting an object are applied to a notebook type personal computer (hereinafter, referred to as “a computer”) 10 is explained. However, the present embodiment is not limited to this example. For example, the present embodiment can also be applied to a remote controller, a television receiver, a hard disk recorder, or the like.

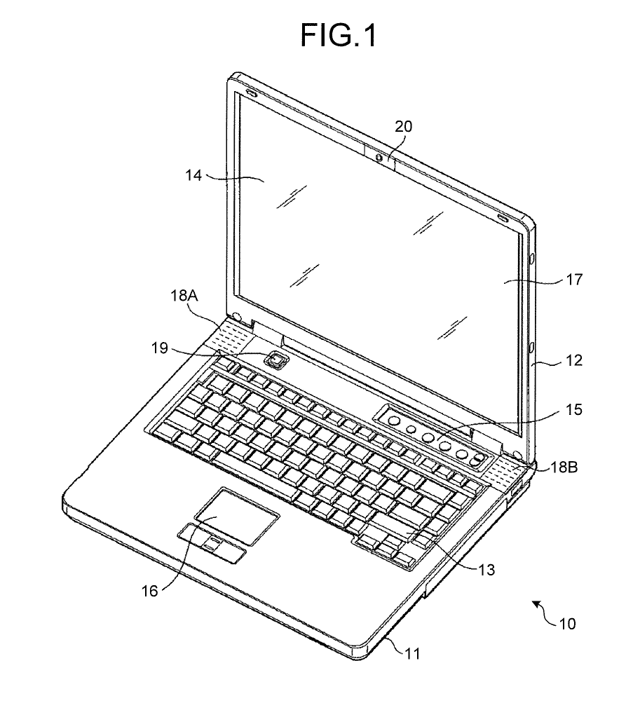

As illustrated in FIG. 1, the computer 10 has a body 11 and a display unit 12. The display unit 12 mounts thereon a display device provided with a liquid crystal display (LCD) 17. The display unit 12 further mounts thereon a touch panel 14 in such a manner that the touch panel 14 covers the surface of the LCD 17. The display unit 12 is attached to the body 11 in such a manner that the display unit 12 is rotatable between an open position such that the upper surface of the body 11 is uncovered and a closed position such that the upper surface of the body 11 is covered with the display unit 12. The display unit 12 is provided with a camera 20 in the upper portion of the LCD 17. The camera 20 is used for picking up an image of an operator or the like of the computer 10 when the display unit 12 is at the open position such that the upper surface of the body 11 is uncovered.

The body 11 has a thin box-shaped casing on which a keyboard 13, an input operation panel 15, a touch pad 16, speakers 18A and 18B, a power button 19 for turning on and off the power supply of the computer 10, and the like are arranged. The input operation panel 15 is provided with various kinds of operation switches thereon.

Furthermore, the body 11 is for example provided with an external display connecting terminal (not illustrated in the drawings) conformed to the high-definition multimedia interface (HDMI) standard on the rear surface thereof. The external display connecting terminal is used for outputting digital video signals to an external display.

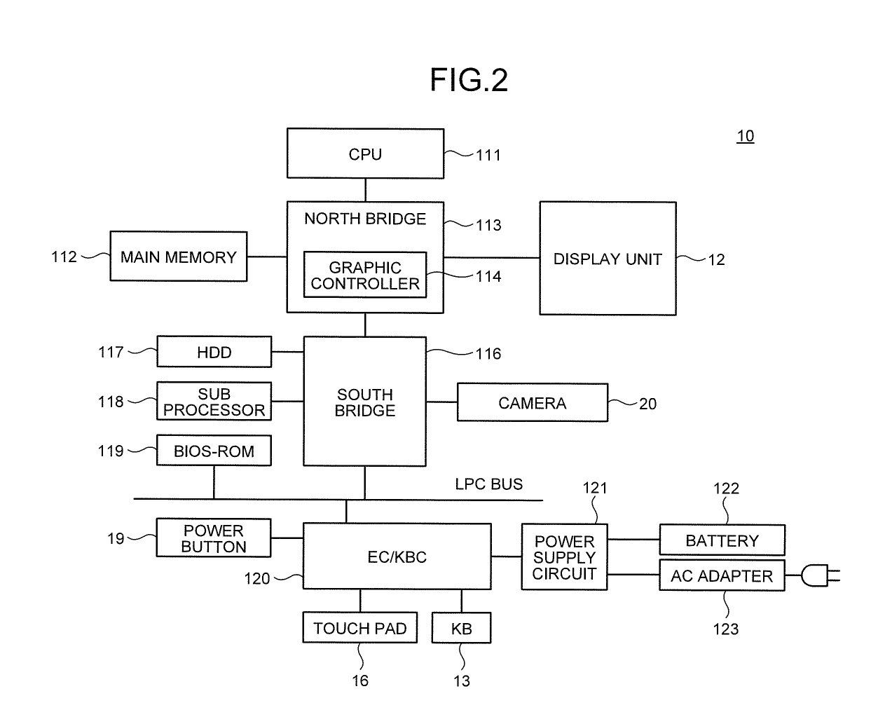

The computer 10 in the present embodiment is, as illustrated in FIG. 2, provided with a central processing unit (CPU) 111, a main memory 112, a north bridge 113, a graphic controller 114, the display unit 12, a south bridge 116, a hard disk drive (HDD) 117, a sub processor 118, a basic input/output system (BIOS)-read only memory (ROM) 119, an embedded controller/keyboard controller (EC/KBC) 120, a power supply circuit 121, a battery 122, an AC adapter 123, the touch pad 16, a keyboard (KB) 13, the camera 20, the power button 19, and the like.

The CPU 111 is a processor for controlling the operation of the computer 10. The CPU 111 executes an operating system (OS) and various kinds of application programs that are loaded from the HDD 117 into the main memory 112. Furthermore, the CPU 111 executes a BIOS stored in the BIOS-ROM 119. The BIOS is a computer program for controlling peripheral devices. The BIOS is executed first when the computer 10 is powered up.

The north bridge 113 is abridge device that connects between a local bus of the CPU 111 and the south bridge 116. The north bridge 113 has a function for performing a communication with the graphic controller 114 via an accelerated graphic port (AGP) bus or the like.

The graphic controller 114 is a display controller for controlling the display unit 12 of the computer 10. The graphic controller 114 generates display signals to be output to the display unit 12 from display data written in a video random access memory (VRAM) (not illustrated in the drawings) by the OS or the application programs.

The south bridge 116 connects thereto the HDD 117, the sub processor 118, the BIOS-ROM 119, the camera 20, and the EC/KBC 120. The south bridge 116 is also provided with an integrated drive electronics (IDE) controller for controlling the HDD 117 and the sub processor 118.

The EC/KBC 120 is a one-chip microcomputer into which an embedded controller (EC) for the control of electric power and a keyboard controller (KBC) for controlling the touch pad 16 and the keyboard (KB) 13 are integrated. For example, the EC/KBC 120 turns on, when the power button 19 is operated, the power supply of the computer 10 in cooperation with the power supply circuit 121. The computer 10 is, when external power is supplied to the computer 10 via the AC adapter 123, driven by an external power source. When the external power is not supplied to the computer 10, the computer 10 is driven by the battery 122.

The camera 20 is a universal serial bus (USB) camera such as a web camera. The USB connector of the camera 20 is connected to a USB port (not illustrating in the drawings) provided to the body 11 of the computer 10. Moving image data (display data) picked up by the camera 20 is stored as frame data in the main memory 112 or the like and can be displayed on the display unit 12. The frame rate of a frame image that constitutes the moving image data picked up by the camera 20 is, for example, 15 frames per second. The camera 20 may be an external camera or a built-in camera in the computer 10.

The sub processor 118 performs, for example, processing of moving image data acquired from the camera 20.

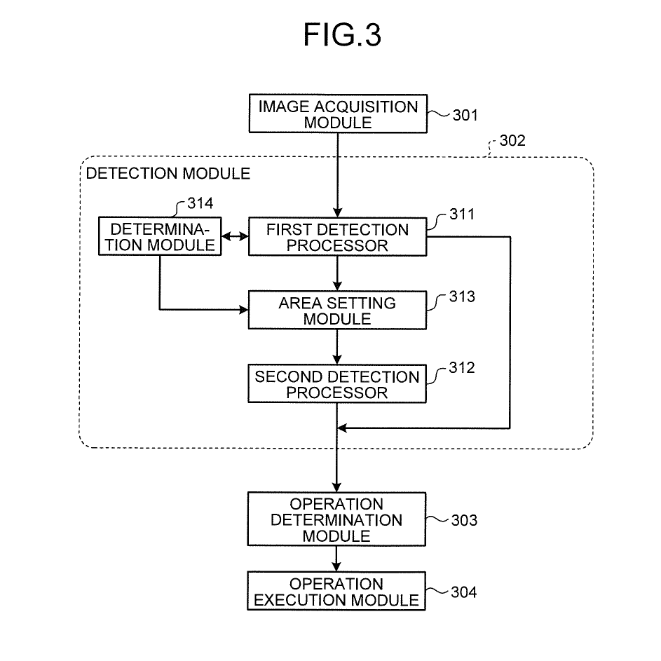

The computer 10 in the present embodiment is, as a functional constitution illustrated in FIG. 3, provided with an image acquisition module 301, a detection module 302, an operation determination module 303, and an operation execution module 304.

The image acquisition module 301 acquires moving image data picked up by the camera 20 to store the moving image data in the HDD 117.

The detection module 302 detects the movement of an object to be detected with respect to a frame image that constitutes the moving image data (the moving image data acquired by the image acquisition module 301) input.

In the present embodiment, the detection module 302 is mainly provided with a first detection processor 311, a second detection processor 312, an area setting module 313, and a determination module 314.

The first detection processor 311 successively detects an object with the first algorithm with respect to the frame image for each frame image that constitutes the moving image data acquired by the image acquisition module 301 to track the object, and detects the movement of the object. Here, the first algorithm is an algorithm using a feature value; that is, an algorithm for searching for an area having a feature value similar to the feature value of an object to be detected by learning. The first algorithm includes, for example, an algorithm such as Histograms of Oriented Gradients (HOG) combined with AdaBoost; however, the present embodiment is not limited to this example.

The second detection processor 312 successively detects an object with the second algorithm with respect to the frame image for each frame image to track the object, and detects the movement of the object. Here, the second algorithm is an algorithm for searching for a movement destination of a predetermined feature area in the frame image without learning but by using pattern matching or the like. The second algorithm includes, for example, an algorithm such as Speeded Up Robust Features (SURF), Scale-Invariant Feature Transform (SIFT), or Phase Only Correlation (POC); however, the present embodiment is not limited to these examples.

The first algorithm is an algorithm that is excellent in noise immunity that is capable of detecting the approximate position or a large movement of an object even with noises such as defocuses in the frame image input. The second algorithm is a precision algorithm capable of detecting a small movement of the object.

That is, the first algorithm detects an object by learning and hence, for example, when detecting a hand as the object, the learning is performed by using hands of various persons thus detecting not only a specific hand but also hands of unspecified persons. Furthermore, when the HOG is adopted as the first algorithm, a histogram of feature values in a whole area is utilized and hence, for example, a profile that seems to be a hand can be detected even in a frame image blurred by being defocused.

Performance of the camera 20 such as the web camera mounted on the computer 10 or the like is not so high and hence, when a user's hand moves in front of the camera 20 at an ordinary speed, the image of the hand is highly likely to be blurred by being defocused. However, in the first algorithm, even with noises in a frame image input in such a manner above, the hand can be detected and tracked.

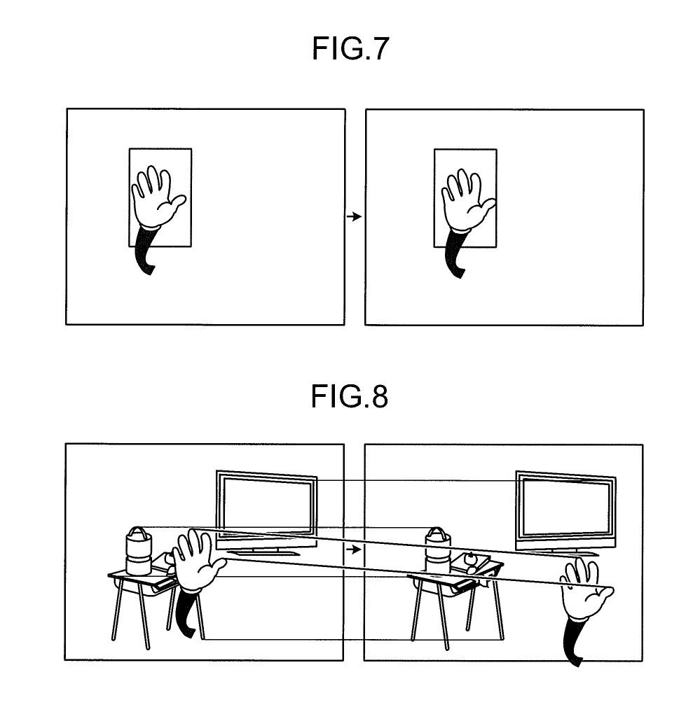

However, in the first algorithm, as illustrated in FIG. 7, an object per se in the frame image, that is, a hand per se currently placed in front of the camera 20 is not tracked and hence, it is difficult to detect a small movement of the hand. Furthermore, in the first algorithm, subtle fluctuation can occur in the detection position of an object in each frame image even though the hand does not move, or fluctuation can occur in the detection position of an object even though the object remains stationary.

In contrast, in the second algorithm for searching for a movement destination of a feature area in a frame image without learning, when an entire image in a screen uniformly moves; for example, to consider a case where scenery is photographed by the camera 20, when camera shake occurs and an input image uniformly moves as a whole, a displacement of the image by tracking a characteristic point can be precisely measured.

Meanwhile, for example, in a case where the POC algorithm is used as the second algorithm, in such a case that an input image is blurred by being defocused; that is, when an image with no feature value is input, it is difficult to detect an object. For example, as illustrated in FIG. 8, in such a case that only a hand moves in front of the camera 20 and only the hand is tracked; that is, when only some of objects in an image move and the objects are tracked, the feature value of a background that is a large part of the image becomes predominant rather than the feature values of some of the objects such as a hand, the feature value of the hand that is a part of the image is affected by the feature value of the background that is a large part of the image and hence, it is difficult to track the hand. That is, when an object is tracked by using the second algorithm, it is necessary to reduce the effect of the background or take measures when an image blurred by being defocused is input.

Accordingly, in the present embodiment, as described below, the above-mentioned problems are overcome by combining object detection results with the first algorithm and object detection results with the second algorithm. In conjunction with FIG. 3 again, the constitution of the present embodiment for overcoming such problems is explained.

The determination module 314 determines a threshold by using a first detection area output as a result of performing object detection by the first detection processor 311. The movement of the object is obtained as a result of performing the object detection by the first detection processor 311. The determination module 314 determines whether the travel of an object based on the movement of the object is smaller than the threshold.

As a result of object detection by the first detection processor 311, a rectangular-shaped first detection area including the object detected is output. The first detection area changes in size depending on the object detected. The determination module 314 determines the threshold based on 1/n (n is an integer) of each of the height H and the width W of the rectangular-shaped first detection area output as a result of detection by the first detection processor 311. To be more specific, the determination module 314 calculates the threshold by using the height H and the width W of the first detection area in the following expression (1).

$$Threshold = \sqrt{{( \frac{H}{2} )}^{n} + {( \frac{W}{2} )}^{n}} \qquad ( 1 )$$

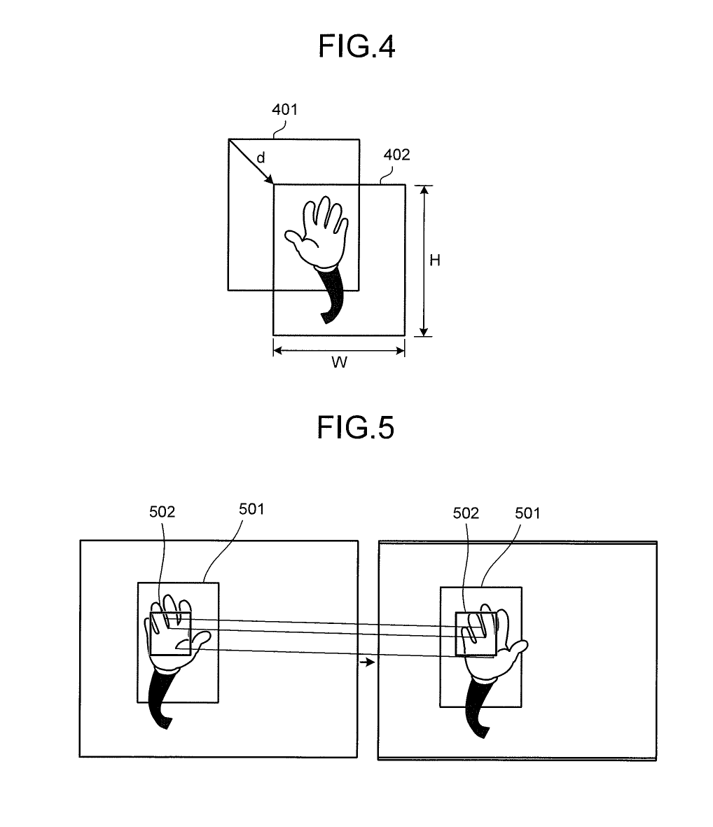

Here, as one example, a case such that n=2 is considered. FIG. 4 is a view for explaining about setting of the threshold. As illustrated in FIG. 4, a case is considered such that the first detection processor 311 outputs a first detection area 401 including an object (a hand as an example in FIG. 4) detected and then outputs a first detection area 402 in the next frame image. In this case, the object moves from the first detection area 401 to the first detection area 402, and the travel of the object is expressed as d.

As illustrated in FIG. 4, when the object is included in a range where the first detection area 401 and the first detection area 402 after the object moves overlap with each other, a second detection area can be set for applying the second algorithm in the range mentioned above. When the travel of the object is large and no range exists where the first detection area 401 and the first detection area 402 overlap with each other, the area setting module 313 cannot set the second detection area. Therefore, the determination module 314 obtains a limit value of the travel d of an object to be included in the range where the first detection area 401 and the first detection area 402 overlap with each other as a threshold by calculating the expression (1).

In conjunction with FIG. 3 again, the area setting module 313 sets, when the determination module 314 determines that the travel d based on the movement of the object is smaller than the threshold, the above-mentioned second detection area with respect to the frame image in the first detection area. Here, since the size of the second detection area is smaller than that of the first detection area, the second detection area is an area supposed to include a smaller amount of background. The area setting module 313 sets, for example, the size and position of the second detection area in the range of the area supposed to include a smaller amount of background depending on the size and position of the area determined by dictionary data used in the first algorithm such as the HOG+AdaBoost.

The area setting module 313 sets, when the determination module 314 determines that the travel based on the movement of the object is smaller than the threshold; that is, when the second detection processor 312 performs detection and tracking processing of an object with the second algorithm, the second detection area smaller in size than the first detection area with respect to the frame image in the first detection area.

Furthermore, the second detection processor 312 detects, when the determination module 314 determines that the travel based on the movement of the object is smaller than the threshold, an object with the second algorithm in the second detection area set with respect to the frame image by the area setting module 313; that is, in the second detection area provided by excluding background from the first detection area.

That is, as illustrated in FIG. 5, in the present embodiment, the first detection processor 311 detects the approximate position of a hand as an object with the first algorithm, a first detection area 501 is provided as a result of detection, and the area setting module 313 sets a second detection area 502, which is supposed to include a smaller amount of background, in the relative position of the first detection area. Due to such a constitution, the second detection area substantially becomes an image of a hand (an object) only and hence, even when the hand slightly moves, the characteristic point is easily tracked thus precisely detecting the travel of the hand.

Accordingly, in the present embodiment, the second detection processor 312 searches the characteristic point with the second algorithm only inside the second detection area and detects a small movement of the hand. Due to such a constitution, in the present embodiment, highly accurate object detection and tracking can be achieved corresponding to both the fast movement and slow movement of an object (a hand).

In conjunction with FIG. 3 again, the operation determination module 303 outputs operation data indicating an operation instruction based on the movement detected by the detection module 302. The operation execution module 304 controls, depending on the operation data output by the operation determination module 303, devices (the display unit 12, the speakers 18A and 18B, the external display, or the like) to be operated.

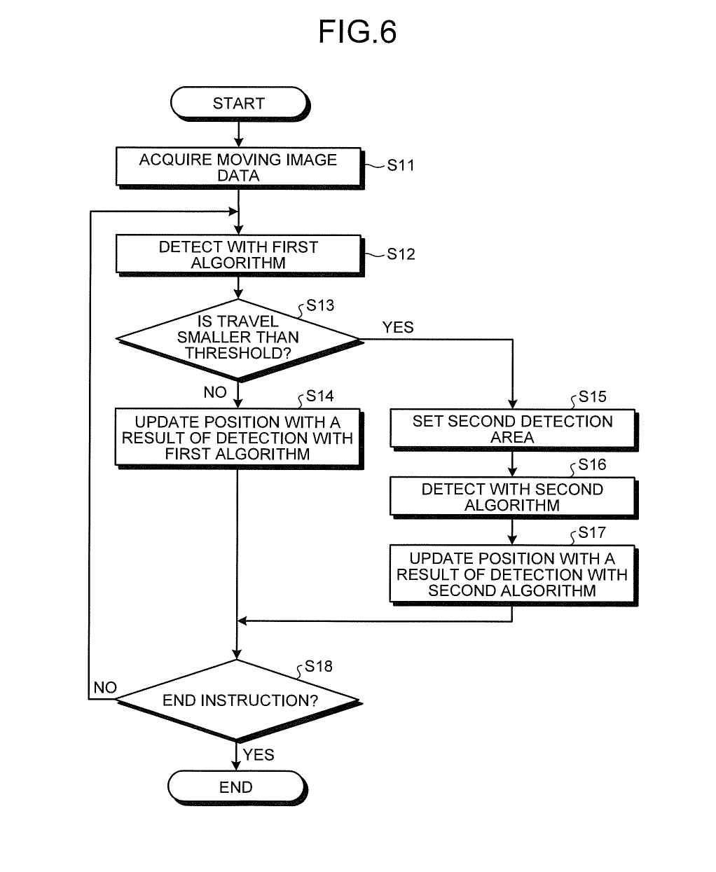

Next, object detection processing constituted as described above in the present embodiment is explained in conjunction with FIG. 6. First of all, the image acquisition module 301 acquires moving image data from the camera 20 (S11).

Furthermore, the first detection processor 311 detects an object in a frame image with the first algorithm (S12). As a result, the first detection processor 311 outputs a first detection area including the object detected.

Next, the determination module 314 obtains, as described above, a threshold by calculation based on the size of the first detection area, and determines whether the travel of the object detected for each frame image is smaller than the threshold (S13). When the travel is equal to or larger than the threshold (No at S13), the first detection processor 311 updates the position of the object with a position obtained as a result of detecting the object with the first algorithm (S14).

On the other hand, at S13, when the travel of the object is smaller than the threshold (Yes at S13), the area setting module 313 sets a second detection area in the first detection area as described above (S15).

The second detection processor 312 detects the object with respect to the second detection area with the second algorithm (S16), and updates the position of the object with a position obtained as a result of detecting the object with the second algorithm (S17).

The above-mentioned processing from S12 to S17 is repeatedly performed until an end instruction is given by a user (No at S18). Furthermore, when the end instruction is given (Yes at S18), the object detection processing is terminated.

In this manner, in the present embodiment, when the first detection processor 311 detects an approximate position of an object with the first algorithm and the travel of the object detected is smaller than a threshold, the second detection area provided by excluding background from the first detection area as a result of detection is set in the relative position of the first detection area, and the second detection processor 312 detects a small movement of the object inside the second detection area with the second algorithm. Hence, highly accurate detection and tracking of the object can be performed corresponding to both a small movement and a large movement of the object without the occurrence of fluctuation.

The program for detecting an object, the program being executed in the computer 10 of the present embodiment is provided as a computer program product in the form of the storage medium capable of being read by the computer; that is, the HDD 117, a CD-ROM, a flexible disk (FD), a CD-R, a digital versatile disk (DVD), or the like in which the program is stored as an installable or executable file.

The program for detecting an object and executed in the computer 10 of the present embodiment maybe stored on another computer connected to a network such as the Internet and provided by downloading it via the network. The program for detecting an object, the program being executed in the computer 10 of the present embodiment may be provided or distributed via a network such as the Internet.

In addition, the program for detecting an object, the program being executed in the computer 10 of the present embodiment may be provided in the form of the read only memory (ROM) or the like into which the program is integrated in advance.

The program for detecting an object, the program being executed in the computer 10 of the present embodiment is constituted of modules including the above-mentioned respective modules (the image acquisition module 301, the determination module 314, the area setting module 313, the first detection processor 311, the second detection processor 312, the operation determination module 303, and the operation execution module 304). As actual hardware, a central processing unit (CPU) 111 reads out the program for detecting an object from the above-mentioned storage medium such as the HDD 117, and executes the program, and thus the above-mentioned respective modules are loaded on the main memory 112, and the image acquisition module 301, the determination module 314, the area setting module 313, the first detection processor 311, the second detection processor 312, the operation determination module 303, and the operation execution module 304 are generated on the main memory 112.

In the present embodiment, a case where the detection module 302 detects the movement of the hand of an operator is explained as one example; however, the present embodiment is not limited to this case. The detection module 302 can be constituted so that the detection module 302 detects the movement of an arbitrary portion of a body other than a hand or the movement of other objects.

In the present embodiment, the operation execution module 304 controls, depending on the operation instruction based on the movement of the hand detected by the detection module 302, a device to be operated; however, the present embodiment is not limited to this case. The movement of an object detected can be used for other purposes than the control of the device to be operated.

In the present embodiment, the determination module 314 obtains a threshold for comparing with the travel of an object from the size of the first detection area as a result of the detection by the first detection processor 311 by calculation; however, the present embodiment is not limited to this case. The threshold may be calculated in advance.

In addition, the image acquisition module 301, the determination module 314, the area setting module 313, the first detection processor 311, the second detection processor 312, the operation determination module 303, and the operation execution module 304 may be constituted of hardware.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A device for detecting an object, the device comprising:
a first detection processor configured to detect an object to be detected with respect to a frame image that constitutes input moving image data, with a first algorithm for searching for an area having a feature value similar to a feature value of the object by learning;
a determination module configured to determine whether a travel based on movement of the object is smaller than a threshold;
an area setting module configured to set, when the travel is smaller than the threshold, a second detection area inside a first detection area in which the object is detected with the first algorithm, the second detection area being smaller in size than the first detection area; and
a second detection processor configured to detect, when the travel is smaller than the threshold, the object in the second detection area with a second algorithm for searching without learning for the movement destination of a feature area in the frame image.

2. The device for detecting an object of claim 1, wherein the first detection processor is configured to update, when the travel is equal to or larger than the threshold, the position of the object based on a result of detection with the first algorithm.

3. The device for detecting an object of claim 1, wherein the determination module is configured to further determine the threshold based on the height and width of the first detection area.

4. A method for detecting an object, the method comprising:
detecting an object to be detected with respect to a frame image that constitutes input moving image data, with a first algorithm for searching for an area having a feature value similar to a feature value of the object by learning;
determining whether a travel based on movement of the object is smaller than a threshold;
setting, when the travel is smaller than the threshold, a second detection area inside a first detection area in which the object is detected with the first algorithm, the second detection area being smaller in size than the first detection area; and
detecting, when the travel is smaller than the threshold, the object in the second detection area with a second algorithm for searching without learning for the movement destination of a feature area in the frame image.

5. A computer program product having a non-transitory computer readable medium including programmed instructions, wherein the instructions, when executed by a computer, cause the computer to perform:
detecting an object to be detected with respect to a frame image that constitutes input moving image data, with a first algorithm for searching for an area having a feature value similar to a feature value of the object by learning;
determining whether a travel based on movement of the object is smaller than a threshold;
setting, when the travel is smaller than the threshold, a second detection area inside a first detection area in which the object is detected with the first algorithm, the second detection area being smaller in size than the first detection area; and
detecting, when the travel is smaller than the threshold, the object in the second detection area with a second algorithm for searching without learning for the movement destination of a feature area in the frame image.
